(19) United States
(12) Patent Application Publication
(10) Pub. No.: US 2017/0016769 A1
(43) Pub. Date: Jan. 19, 2017

(54) MEASUREMENT SYSTEM OF REAL-TIME SPATIALLY-RESOLVED SPECTRUM AND TIME-RESOLVED SPECTRUM AND MEASUREMENT MODULE THEREOF

(71) Applicant: HC PHOTONICS CORP., Hsinchu (TW)

(72) Inventors: Ming-Hsien CHOU, Hsinchu (TW); Jian-Long XIAO, Hsinchu (TW); Ya-Wen CHUANG, Hsinchu (TW); Jyh-Rou SZE, Hsinchu (TW); Po-Jui CHEN, Hsinchu (TW); Chun-Fu LIN, Hsinchu (TW); Long-Jeng LEE, Hsinchu (TW); Chun-Li CHANG, Hsinchu (TW); Chi Hung HUANG, Hsinchu (TW); Da-Ren LIU, Hsinchu (TW)

(73) Assignee: HC PHOTONICS CORP.

(21) Appl. No.: 14/825,252

(22) Filed: Aug. 13, 2015

(30) Foreign Application Priority Data
Jul. 14, 2015 (TW) 104122825

(51) Int. Cl. G01J 3/44; G01N 21/64

(52) U.S. Cl. CPC G01J 3/4406; G01N 21/6456; G01N 21/6408; G01N 2201/06113; G01N 2201/0697; G01N 2201/10

(57) ABSTRACT

The present invention provides a measurement system of real-time spatially-resolved spectrum and time-resolved spectrum and a measurement module thereof. The measurement system includes an excitation light and a measurement module. The excitation light excites a fluorescent sample and the measurement module receives and analyzes fluorescence emitted by the fluorescent sample. The measurement module includes a single-photon linear scanner and a linear CCD spectrometer. The single-photon linear scanner selectively intercepts a light beam component of a multi-wavelength light beam that has a predetermined wavelength to generate a single-wavelength time-resolved signal, wherein the multi-wavelength light beam is generated by splitting the fluorescence. The linear CCD spectrometer receives the multi-wavelength light beam and generates a spatially-resolved full-spectrum fluorescence signal. With the implementation of the present invention, the spatially-resolved full-spectrum fluorescence signal and the single-wavelength time-resolved signal can be observed at the same time. Thus, the facility of a fluorescence spectrometer is improved.

### BACKGROUND OF THE INVENTION

1. Technical Field

The present invention relates to a measurement system of a real-time spatially-resolved spectrum and time-resolved spectrum and a measurement module thereof. More particularly, the present invention relates to such a measurement system and module that are applicable to a fluorescence spectrometer.

2. Description of Related Art

Fluorescence detection has found application in various fields. For example, it can be used to analyze and monitor the manufacturing process of an optoelectronic material; or be used in biomedical imaging and clinical diagnosis and treatment as a means of serum immunoassay, of developing medicines for stem cell tracking, or of clinical cancer diagnosis and treatment; or be used to establish the industrial specification standards of fluorescent materials.

The physical mechanism by which a fluorescence emission is generated can be identified by the lifetime of the fluorescence. More information can be obtained on a molecular level by looking into the excited state and decay process of the light-emitting material or structure after photoexcitation. The fluorescence lifetime can be measured in many ways, such as by phase-sensitive detection, time-resolved analog detection, or streak camera detection.

FIG. 1A is a schematic drawing of a conventional fluorescence lifetime sensing platform which incorporates a time-correlated single-photon counting system (TCSPC system). As shown in the drawing, the semiconductor pulse laser 60 emits a light beam, which is focused by the first lens L1 onto the fluorescent sample 40. Consequently, the fluorescent sample 40 generates fluorescence as well as a reflection of the laser beam. It is important that the reflection of the laser beam is kept from entering the second lens L2. Only the fluorescence generated by the fluorescent sample 40 is allowed to pass through the second lens L2 so that the fluorescence emitted from the fluorescent sample 40 is collimated. The collimated light is focused onto the spectrometer 10 by the third lens L3. In front of the slit inlet of the spectrometer 10 is a long pass filter L4 for filtering out light of a wavelength of 532±10 nm to remove both stray light and the excitation light.

In practice, the first lens L1 and the semiconductor pulse laser 60 can be replaced by a single-unit excitation light source. In other words, the first lens L1 can be provided in the excitation light source in order to focus the light beam emitted by the semiconductor pulse laser 60, and in that case, the excitation light source will be able to generate a focused light beam directly. The second lens L2, on the other hand, can be substituted with an optical fiber, as shown in FIG. 1B, in which the optical fiber 70 not only guides the light beam focused by the first lens L1 to the fluorescent sample 40 (indicated by the white arrows), but also guides the fluorescence emitted by the fluorescent sample 40 to the spectrometer 10′ (indicated by the black arrows); and in which the spectrometer 10′ is provided therein with the third lens L3 and the filter L4 in FIG. 1A.

Before measurement, the spectrometer 10 must be set with the fluorescence wavelength to be measured. This can be done by rotating the grating in the spectrometer 10 so that light of a predetermined wavelength can be measured with the spectrometer 10. During measurement, the fluorescence photon signal is received by a fast-response photomultiplier tube for example, and the time of occurrence of fluorescence photons is recorded by the computer PC, which then plots a graph showing how fluorescence intensity changes with time.

The spectrometer 10 used in the conventional fluorescence lifetime sensing platform is stationary and therefore lacks mobility. Moreover, rotating the grating beforehand in accordance with the wavelength to be measured entails additional setting time and compromises system stability.

### BRIEF SUMMARY OF THE INVENTION

The present invention relates to a measurement system of a real-time spatially-resolved spectrum and time-resolved spectrum and a measurement module thereof. The measurement system and module can measure not only a single-wavelength time-resolved signal (i.e., real-time time-resolved spectrum), which is related to the fluorescence lifetime, but also a full-spectrum fluorescence signal (i.e., real-time spatially-resolved spectrum). In addition, the use of a single-photon linear scanner, in which the detection element can be linearly moved by a stepper motor in order to perform time-resolved spectrometry on single-wavelength light, eliminates the need for the user to rotate a grating as conventionally required and increases system stability substantially.

The present invention provides A measurement system of a real-time spatially-resolved spectrum and time-resolved spectrum, comprising: an excitation light source for exciting a fluorescent sample; and a measurement module for receiving and analyzing fluorescence emitted by the fluorescent sample upon excitation, the measurement module comprising: a light-collecting and splitting optical assembly for collecting the fluorescence, splitting the fluorescence according to wavelength, and thereby generating a multi-wavelength light beam of a plurality of wavelengths; a single-photon linear scanner linearly movable along a path non-parallel to an optical path of the multi-wavelength light beam in order to selectively intercept a light beam component of the multi-wavelength light beam that has a predetermined wavelength and thereby generate a single-wavelength time-resolved signal; a linear charge-coupled device (CCD) spectrometer located on the optical path of the multi-wavelength light beam in order to receive the multi-wavelength light beam and generate a spatially-resolved full-spectrum fluorescence signal; and a control and processing module for receiving and analyzing the single-wavelength time-resolved signal and the spatially-resolved full-spectrum fluorescence signal.

The present invention also provides a measurement module applicable to a measurement system of a real-time spatially-resolved spectrum and time-resolved spectrum, comprising: a light-collecting and splitting optical assembly for collecting fluorescence emitted by a fluorescent sample upon excitation, splitting the fluorescence according to wavelength, and thereby generating a multi-wavelength light beam of a plurality of wavelengths; a single-photon linear scanner linearly movable along a path non-parallel to an optical path of the multi-wavelength light beam in order to selectively intercept a tight beam component of the multi-wavelength light beam that has a predetermined wavelength and thereby generate a single-wavelength time-resolved signal; a linear charge-coupled device (CCD) spectrometer located on the optical path of the multi-wavelength light beam in order to receive the multi-wavelength light beam and generate a spatially-resolved full-spectrum fluorescence signal; and a control and processing module for receiving and analyzing the single-wavelength time-resolved signal and the spatially-resolved full-spectrum fluorescence signal.

Implementation of the present invention at least involves the following inventive steps:

1. The linear CCD spectrometer and the single-photon linear scanner coexist so that a spatially-resolved full-spectrum fluorescence signal and a single-wavelength time-resolved signal can be observed at the same time. This arrangement helps increase the convenience of use of a fluorescence spectrometer.

2. A stepper motor is used to move the SPAD detection element linearly so that time-resolved spectrometry can be performed on single-wavelength light without the user having to rotate any grating. This arrangement enhances system stability greatly.

Hereinafter, the detailed features and advantages of the present invention are described in detail by way of the preferred embodiments of the present invention so as to enable persons skilled in the art to gain insight into the technical disclosure of the present invention, implement the present invention accordingly, and readily understand the objectives and advantages of the present invention by making reference to the disclosure of the specification, the claims, and the drawings of the present invention.

### BRIEF DESCRIPTION OF THE SEVERAL VIEWS OF THE DRAWINGS

FIG. 1A is a schematic drawing of a conventional fluorescence lifetime sensing platform;

FIG. 1B schematically shows how the light beam focused by the first lens is guided to the fluorescent sample by an optical fiber;

FIG. 2 is a block diagram of the measurement system of a real-time spatially-resolved spectrum and time-resolved spectrum in an embodiment of the present invention;

FIG. 3 is a block diagram of the measurement module in an embodiment of the present invention;

FIG. 4 to FIG. 6 are block diagrams showing how the single-photon linear scanner in an embodiment of the present invention selectively measures light of a single predetermined wavelength;

FIG. 7 shows the full fluorescence spectrum of the fluorescent sample in an embodiment of the present invention;

FIG. 8A to FIG. 8D show the spectra obtained by the linear CCD spectrometer in an embodiment of the present invention when the stepper motor is linearly moved along a path which is non-parallel to the optical path of the multi-wavelength light beam generated by light-collecting and splitting optical assembly;

FIG. 9 is a block diagram of an embodiment of the present invention which further includes a synchronous signal converter;

FIG. 10A shows the full fluorescence spectrum of the fluorescent sample in an embodiment of the present invention, wherein the sample is different from that in the embodiment of FIG. 7;

FIG. 10B shows the spectrum obtained by the linear CCD spectrometer in an embodiment of the present invention when the reflective mirror has moved to a position corresponding to a peak of about 580 rim of the full fluorescence spectrum in FIG. 10A; and

FIG. 10C shows the 580-nm fluorescence spectrum obtained by subtracting the spectrum in FIG. 10B from that in FIG. 10A.

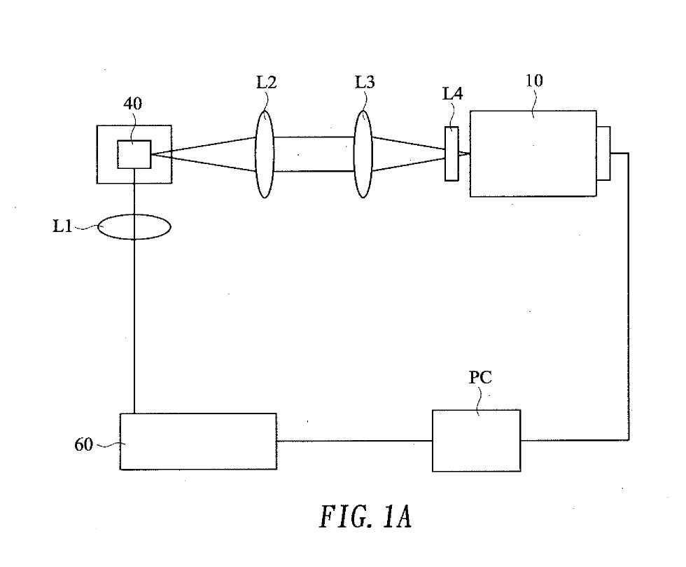

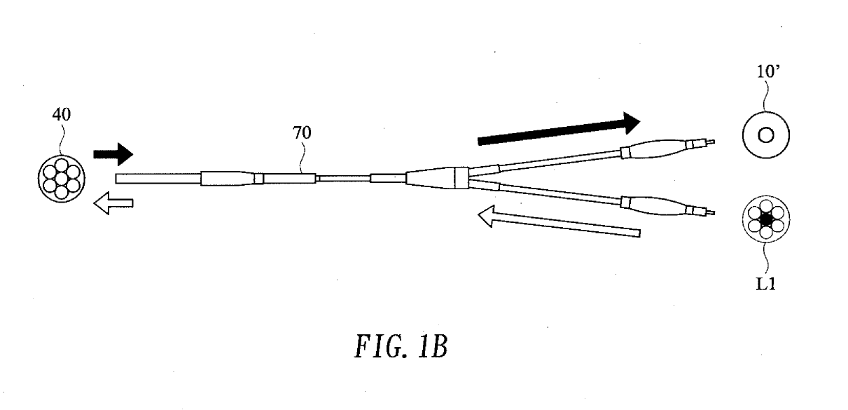

### DETAILED DESCRIPTION OF THE INVENTION

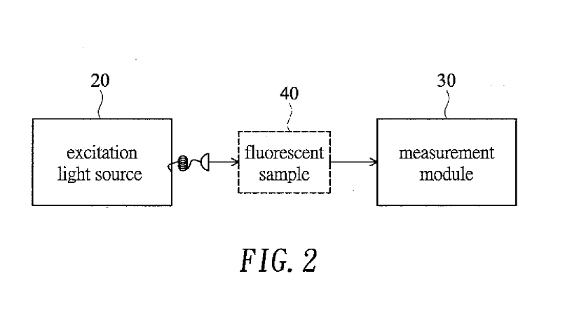

Referring to FIG. 2 for an embodiment of the present invention, a measurement system of a real-time spatially-resolved spectrum and time-resolved spectrum includes an excitation light source 20 and a measurement module 30.

The excitation light source 20 serves to excite a fluorescent sample 40 and can be an ultrafast laser. For instance, an ultrafast laser beam can be generated by a femtosecond oscillator with a central wavelength of 1064 nm, a peak power of 8.5 kW, a pulse width of 210 fs, and a pulse repetition rate of 9.5 MHz. The fluorescent sample 40 emits fluorescence when excited by an ultrafast laser beam, and the measurement module 30 receives and analyzes the fluorescence emitted by the excited fluorescent sample 40.

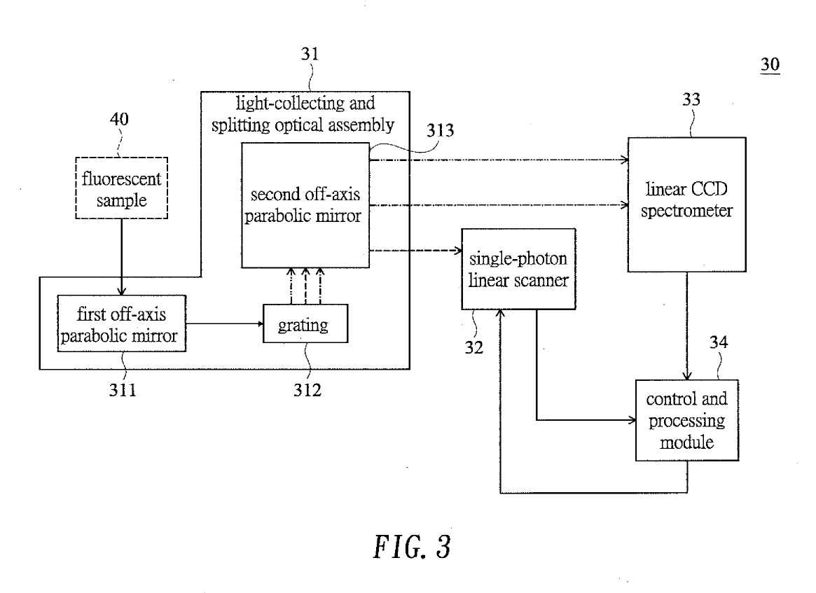

As shown in FIG. 3, the measurement module 30 includes a light-collecting and splitting optical assembly 31, a single-photon linear scanner 32, a linear charge-coupled device (CCD) spectrometer 33, and a control and processing module 34.

The light-collecting and splitting optical assembly 31 is configured to collect fluorescence and split the collected fluorescence according to wavelength so as to generate a multi-wavelength light beam of a plurality of wavelengths, thereby facilitating analysis of the fluorescence.

The light-collecting and splitting optical assembly 31 includes a first off-axis parabolic mirror 311, a grating 312, and a second off-axis parabolic mirror 313. The first off-axis parabolic mirror 311 is located on the optical path along which fluorescence is emitted, and serves to collect and reflect the fluorescence. The grating 312 is located on the optical path along which the fluorescence reflected by the first off-axis parabolic mirror 311 travels, and serves to receive the fluorescence reflected by the first off-axis parabolic mirror 311 and split it according to wavelength so as to generate a multi-wavelength light beam. The reflective surface of the grating 312 has straight engraved lines arranged at a density of 300 to 2400 lines per millimeter. The second off-axis parabolic mirror 313 is located on the optical path of the multi-wavelength light beam generated by the grating 312 and serves to receive and reflect the multi-wavelength light beam. Please note that, once the multi-wavelength light beam exits the light-collecting and splitting optical assembly 31, the single-wavelength light beam components of the multi-wavelength light beam travel along different optical paths respectively.

The single-photon linear scanner 32 is linearly moved along a path which is non-parallel to the optical path of the multi-wavelength light beam generated by light-collecting and splitting optical assembly 31 so as to selectively intercept a light beam component of the multi-wavelength light beam that has a predetermined wavelength and thereby generate a single-wavelength time-resolved signal.

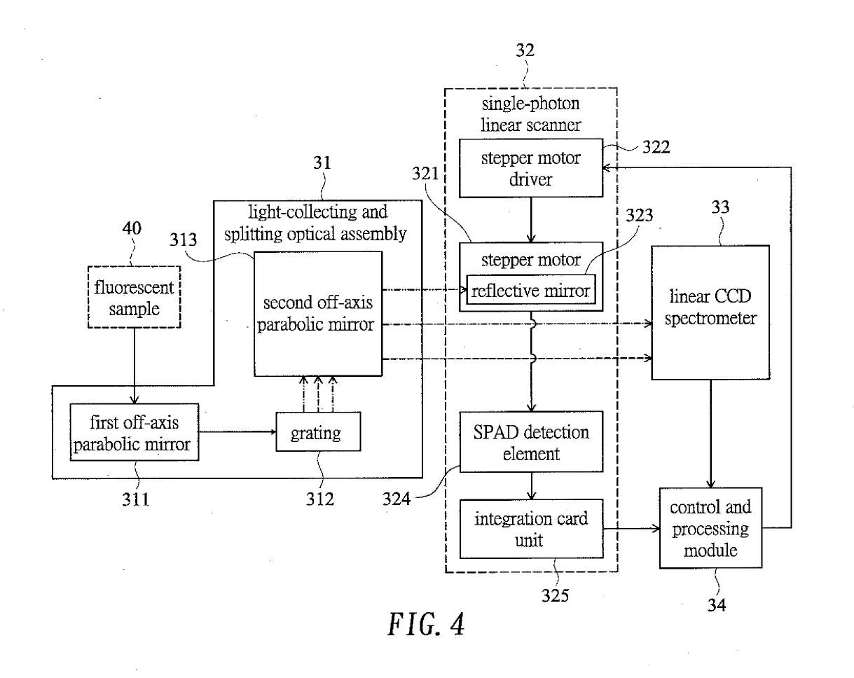

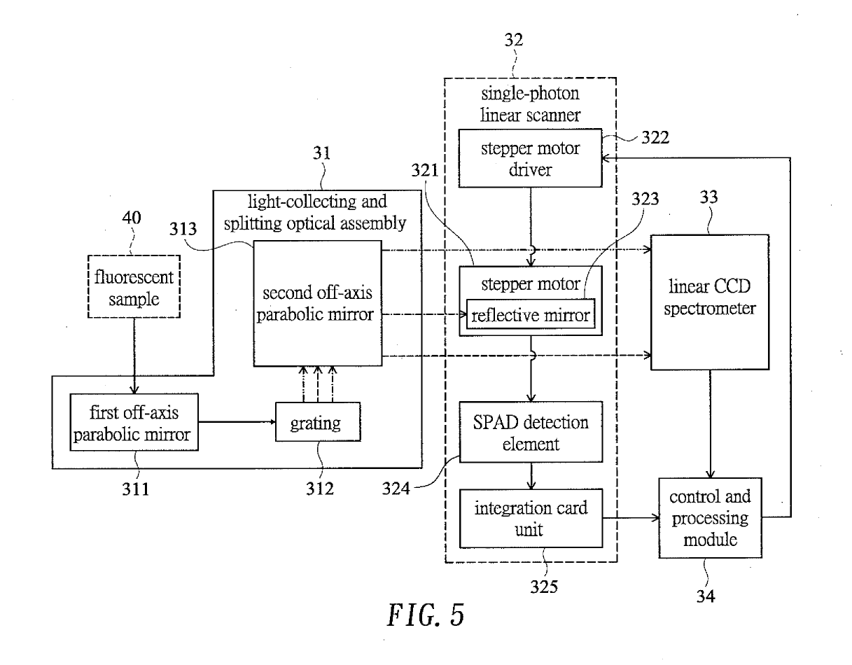

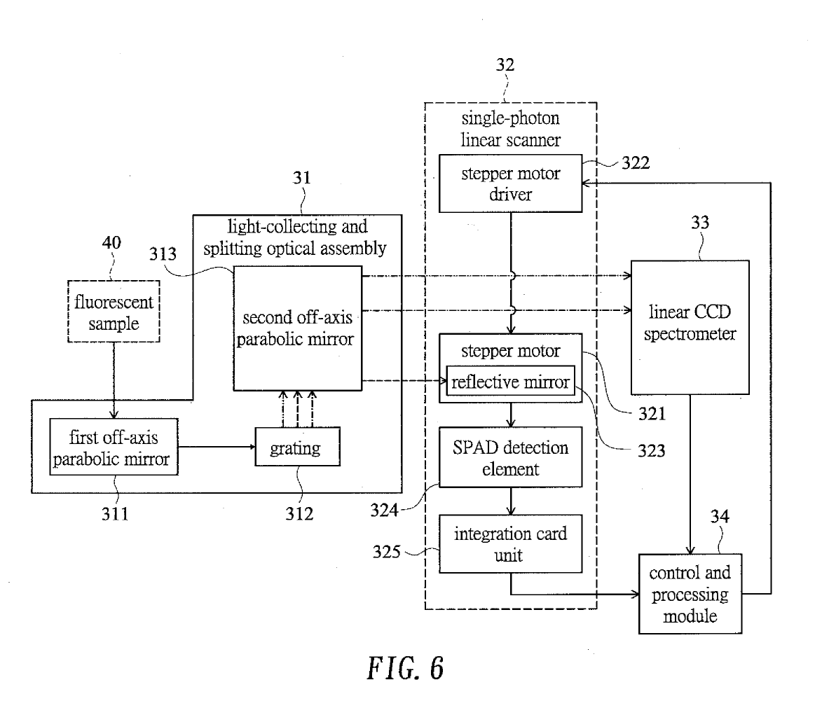

As shown in FIG. 4 to FIG. 6, the single-photon linear scanner 32 includes a stepper motor 321, a stepper motor driver 322, a reflective mirror 323, a single-photon avalanche diode (SPAD) detection element 324, and an integration card unit 325.

The stepper motor 321 is mechanically connected to the stepper motor driver 322, and the stepper motor driver 322 is electrically connected to the control and processing module 34 in order to move the stepper motor 321 linearly under the control of the control and processing module 34. The reflective mirror 323 is connected to the stepper motor 321 and is linearly moved together with the stepper motor 321. More specifically, the reflective mirror 323 can be selectively moved to the optical path of a light beam component of the multi-wavelength light beam that has a predetermined wavelength, so as to reflect the light beam component to the SPAD detection element 324, which is located on the optical path along which the light beam component will travel after being reflected, thereby allowing light beam components of particular wavelengths to be reflected in a selective manner. The light beam component reflected by the reflective mirror 323 and having the predetermined wavelength is received by the SPAD detection element 324, which generates a fluorescence photon detection signal in response.

As the light beam generated by the wavelength-based light-splitting process of the grating 312 and exiting the light-collecting and splitting optical assembly 31 is a multi-wavelength light beam, its light beam components, which have different wavelengths respectively, are shown in FIG. 4 through FIG. 6 as separate line segments. Once the reflective mirror 323 is moved to the optical path of a light beam component of a particular wavelength, the light beam component can be measured.

The integration card unit 325 receives the fluorescence photon detection signal, performs integration to generate the single-wavelength time-resolved signal, and sends the single-wavelength time-resolved signal to the control and processing module 34, The generation of single-wavelength time-resolved signals is well-known in the art and hence will not be dealt with herein.

The linear CCD spectrometer 33 is located on the optical path of the multi-wavelength light beam generated by light-collecting and splitting optical assembly 31 and is configured to receive the multi-wavelength light beam and generate a spatially-resolved full-spectrum fluorescence signal. The techniques by which the linear CCD spectrometer 33 analyzes the multi-wavelength light beam and generates the spatially-resolved full-spectrum fluorescence signal are well-known in the art and hence will not be described herein.

The control and processing module 34 receives and analyzes the single-wavelength time-resolved signal and the spatially-resolved full-spectrum fluorescence signal. The control and processing module 34 may include a man-machine interface in a computer system so that, through the man-machine interface, the user can input the direction in which and the distance by which the stepper motor 321 is to be moved, thereby selecting the wavelength to be measured and instructing the control and processing module 34 how to control the stepper motor driver 322. According to the user's selection, the single-wavelength time-resolved signal of the predetermined wavelength and the spatially-resolved full-spectrum fluorescence signal of the fluorescent sample can be displayed at the same time, or only one of them is displayed.

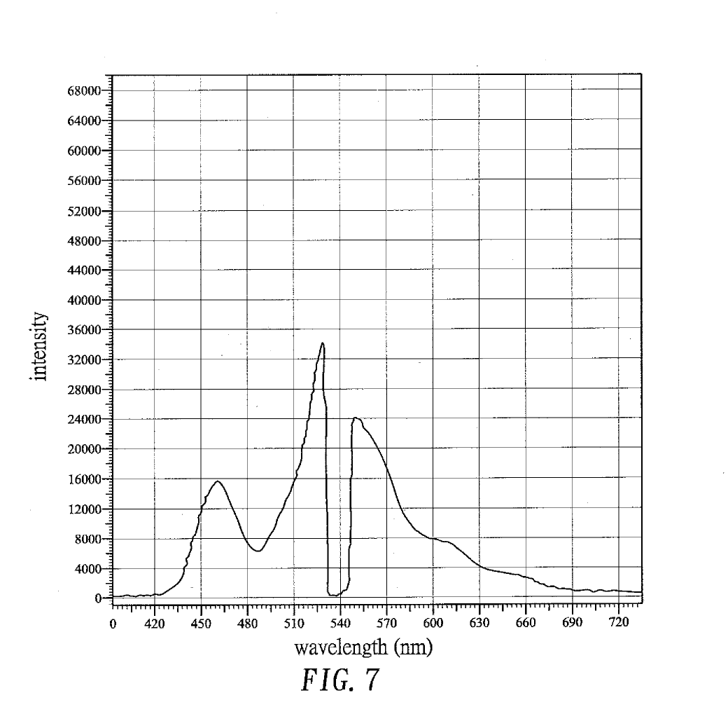

With reference to FIG. 7, which shows the full fluorescence spectrum of a fluorescent sample, the following paragraphs explain how a single-wavelength time-resolved signal of a particular wavelength is measured by moving the reflective mirror 323 linearly with the stepper motor 321.

Initially, the stepper motor 321 is outside the measuring area of the linear CCD spectrometer 33. Since none of the light beam components of the multi-wavelength light beam is intercepted by the single-photon linear scanner 32, the linear CCD spectrometer 33 can observe the spatially-resolved spectrum in full (from 400 nm to 700 nm).

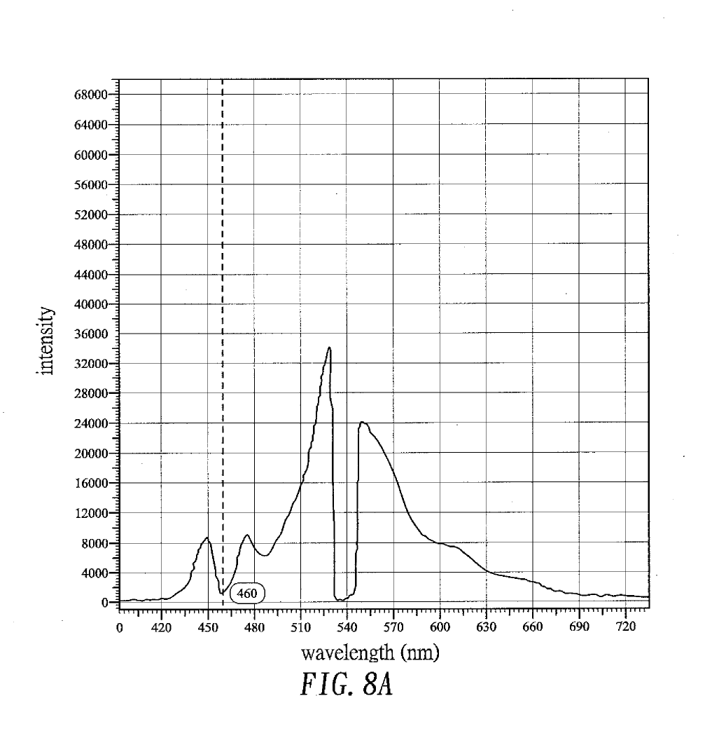

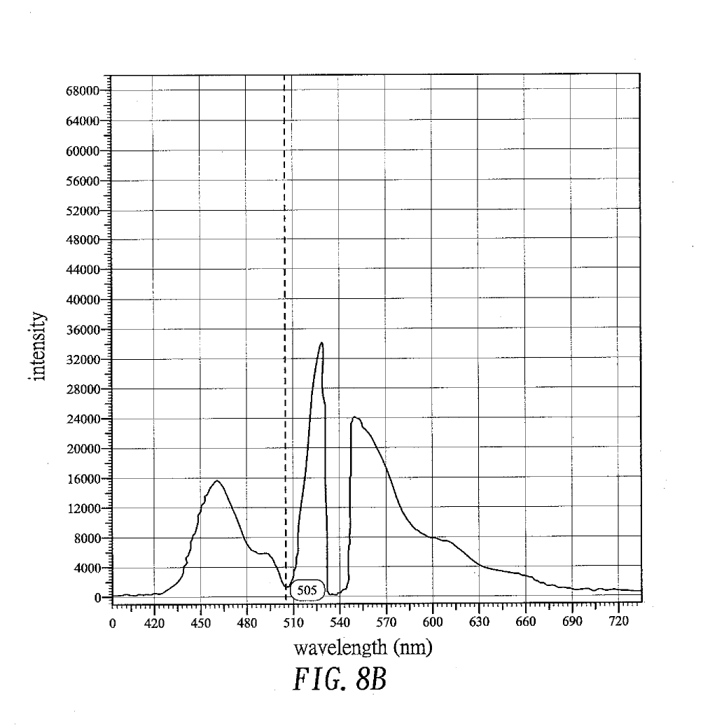

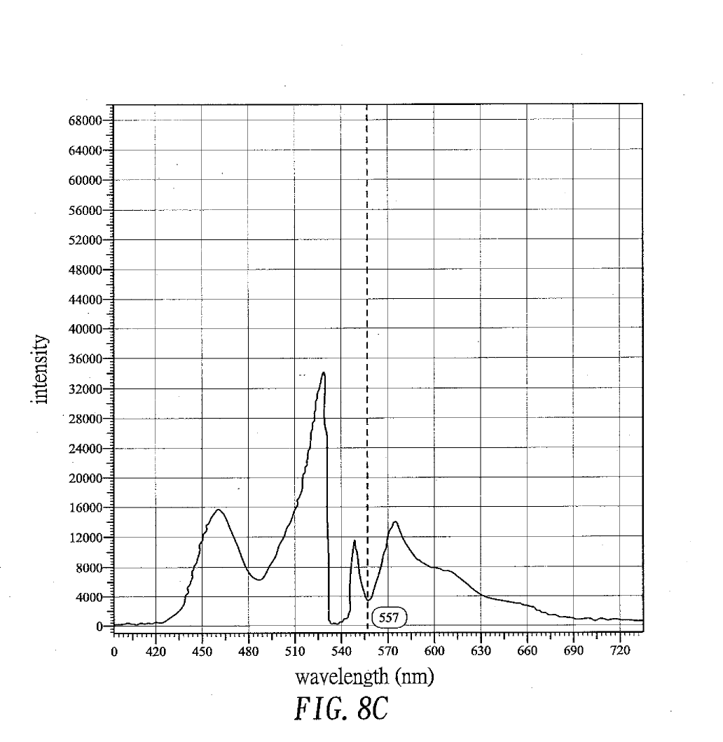

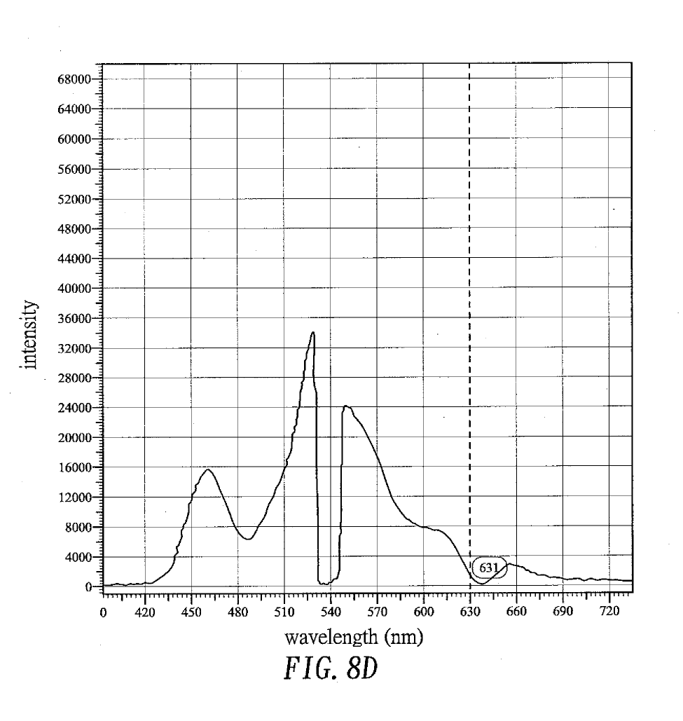

Then, with the control and processing module 34 controlling the stepper motor driver 322, the stepper motor 321 is linearly moved and thus changes the location of the reflective mirror 323, in order for the reflective mirror 323 to reflect the light beam component of a predetermined wavelength to the SPAD detection element 324, and for the single-photon linear scanner 32 to generate a time-resolved spectrum as a result. FIG. 8A to FIG. 8D show the spectra obtained by the linear CCD spectrometer 33 when the stepper motor 321 is linearly moved along a path which is non-parallel to the optical path of the multi-wavelength light beam generated by light-collecting and splitting optical assembly 31. As can be seen in the spectra in FIG. 8A to FIG. 8D, when the single-photon linear scanner 32 selectively measures the 460-nm, 505-nm, 557-nm, and 631-nm light beam components, the linear CCD spectrometer 33 does not receive light of those particular wavelengths. This demonstrates that the single-photon linear scanner 32 can accurately select and measure light of a particular wavelength.

The foregoing measurement system of a real-time spatially-resolved spectrum and time-resolved spectrum can measure a spatially-resolved full-spectrum fluorescence signal and a single-wavelength time-resolved signal separately and thus provides great convenience of use.

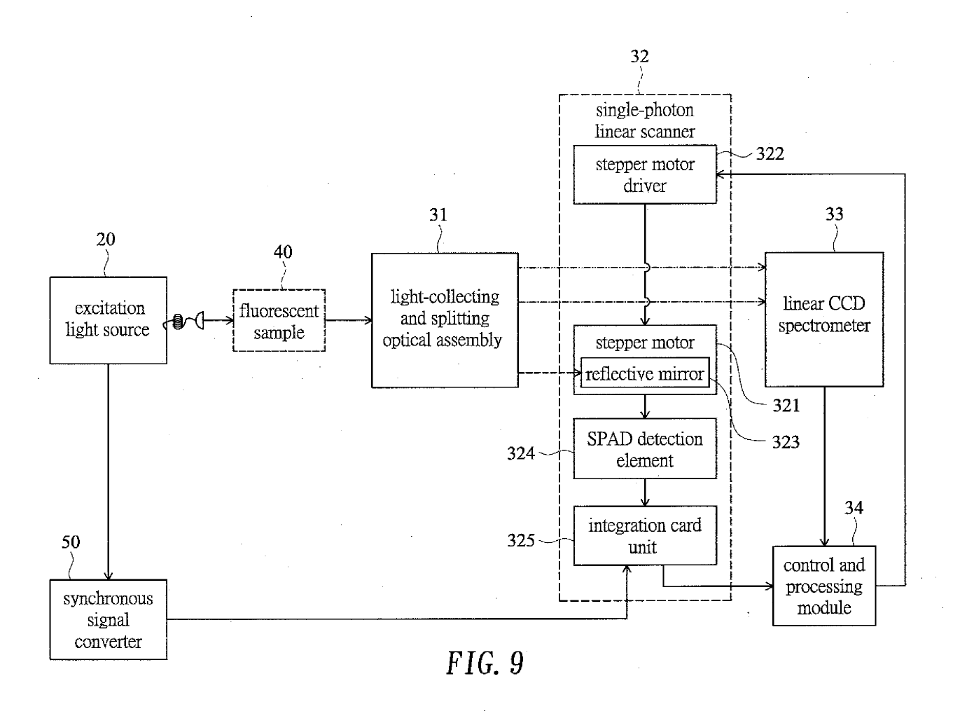

Referring to FIG. 9, the measurement system may further include a synchronous signal converter 50. As shown in FIG. 9, a portion of the light beam emitted by the excitation light source 20 is guided by a light-splitting element (not shown) toward the synchronous signal converter 50. When subjected to photoexcitation of the excitation light source 20, the synchronous signal converter 50 generates an electrical trigger signal and sends the signal to the integration card unit 325. In other words, the synchronous signal converter 50 must be located on the optical path of the aforesaid light beam of the excitation light source 20 and be electrically connected to the integration card unit 325. Once the synchronous signal converter 50 is subjected to photoexcitation, the integration card unit 325 begins timing and generates a single-wavelength time-resolved signal according to the fluorescence photon detection signal received.

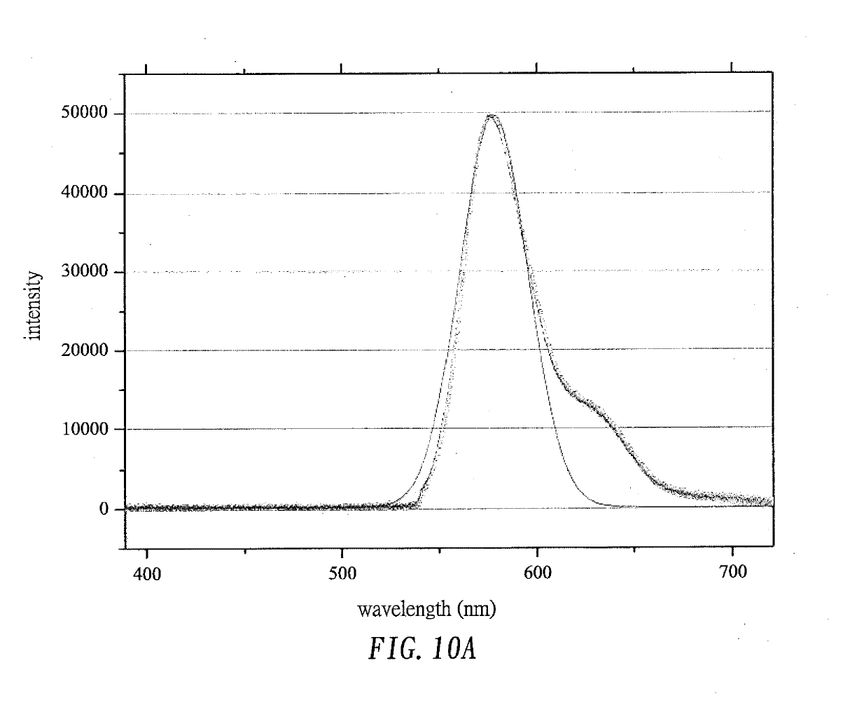

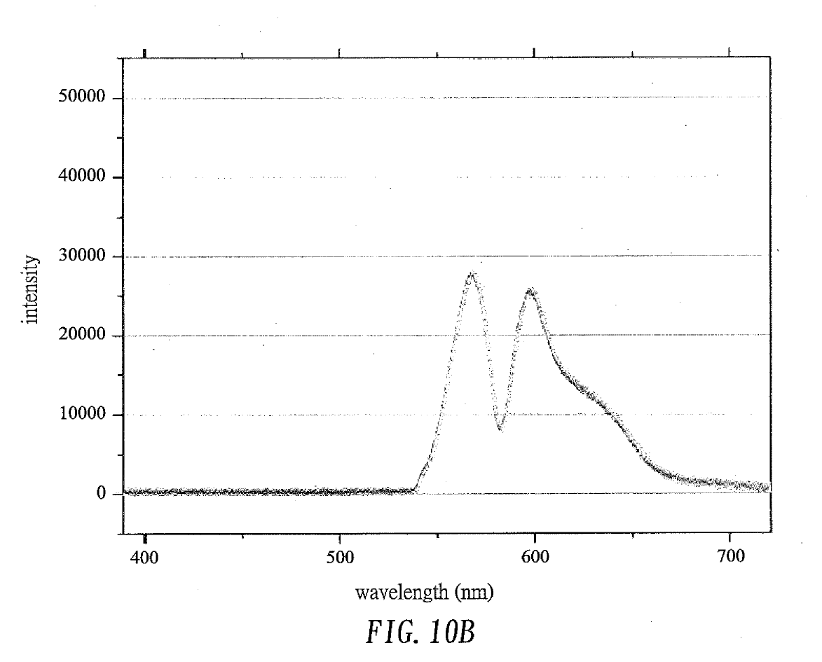

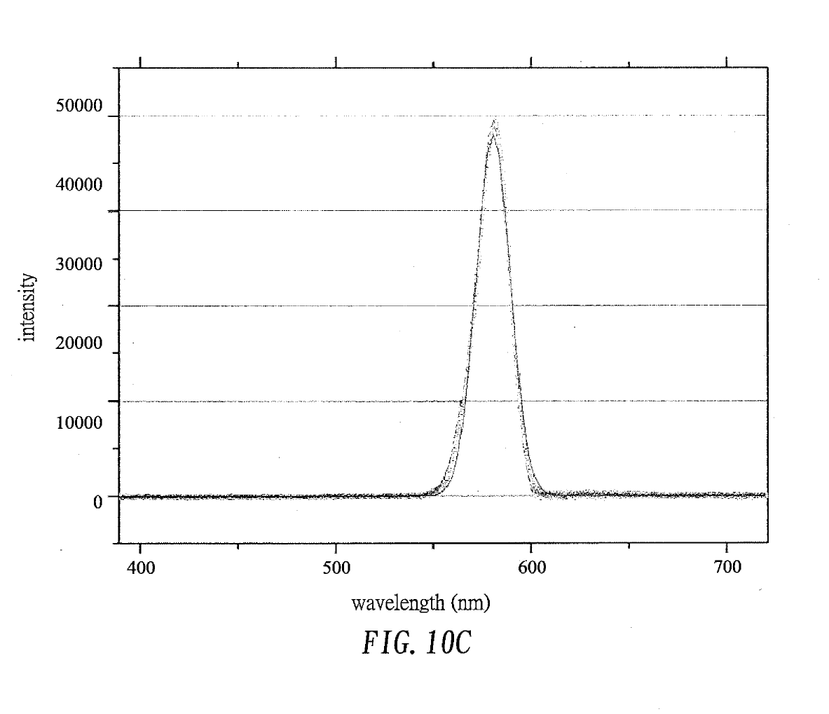

Referring to FIG. 10A to FIG. 10C, the foregoing measurement system of a real-time spatially-resolved spectrum and time-resolved spectrum can also be used to observe the spatially-resolved spectrum of light of a predetermined wavelength. FIG. 10A shows the full spatially-resolved spectrum observed when the stepper motor 321 is in its initial state, i.e., outside the measuring area of the linear CCD spectrometer 33. By controlling the stepper motor 321, the reflective mirror 323 is subsequently moved to a position corresponding to a peak of about 580 nm of the fluorescence curve such that the linear CCD spectrometer 33 obtains the spectrum shown in FIG. 10B. Then, the spectrum in FIG. 10B is subtracted from that in FIG. 10A through computation and processing of the control and processing module 34 to produce the 580-nm fluorescence spectrum in FIG. 10C.

According to the above, the single-photon linear scanner 32 can generate a single-wavelength time-resolved signal so that a time-resolved spectrum of light of a predetermined wavelength can be displayed on a man-machine interface. Also, by mean of signal processing, a spatially-resolved spectrum of light of the same wavelength can be simultaneously displayed on the man-machine interface, allowing the user to observe the spatially-resolved spectrum and time-resolved spectrum of light of a particular wavelength at the same time, which lends enhanced functionality to the measurement system of the present invention.

The features of the present invention are disclosed above by the preferred embodiments to allow persons skilled in the art to gain insight into the contents of the present invention and implement the present invention accordingly. The preferred embodiments of the present invention should not be interpreted as restrictive of the scope of the present invention. Hence, all equivalent modifications or amendments made to the aforesaid embodiments should fall within the scope of the appended claims.

What is claimed is:

1. A measurement system of a real-time spatially-resolved spectrum and time-resolved spectrum, comprising:
an excitation light source for exciting a fluorescent sample; and
a measurement module for receiving and analyzing fluorescence emitted by the fluorescent sample upon excitation, the measurement module comprising:
a light-collecting and splitting optical assembly for collecting the fluorescence, splitting the fluorescence according to wavelength, and thereby generating a multi-wavelength light beam of a plurality of wavelengths;
a single-photon linear scanner linearly movable along a path non-parallel to an optical path of the multi-wavelength light beam in order to selectively intercept a light beam component of the multi-wavelength light beam that has a predetermined wavelength and thereby generate a single-wavelength time-resolved signal;
a linear charge-coupled device (CCD) spectrometer located on the optical path of the multi-wavelength light beam in order to receive the multi-wavelength light beam and generate a spatially-resolved full-spectrum fluorescence signal; and
a control and processing module for receiving and analyzing the single-wavelength time-resolved signal and the spatially-resolved full-spectrum fluorescence signal.

2. The measurement system of claim 1, wherein the excitation light source is an ultrafast laser.

3. The measurement system of claim 1, wherein the light-collecting and splitting optical assembly comprises:
a first off-axis parabolic mirror for collecting and reflecting the fluorescence;
a grating for receiving the fluorescence reflected by the first off-axis parabolic mirror, and for splitting the fluorescence according to wavelength and thereby generating the multi-wavelength light beam; and
a second off-axis parabolic mirror for receiving and reflecting the multi-wavelength light beam.

4. The measurement system of claim 3, wherein the grating has a reflective surface provided with a plurality of straight engraved lines arranged at a density of 300 to 2400 said straight engraved lines per millimeter.

5. The measurement system of claim 1, wherein the single-photon linear scanner comprises:
a stepper motor;
a stepper motor driver for driving the stepper motor into linear movement, under control of the control and processing module;
a reflective mirror connected to and linearly movable along with the stepper motor in order to selectively reflect the light beam component having the predetermined wavelength;
a single-photon avalanche diode (SPAD) detection element located on an optical path along which the light beam component having the predetermined wavelength travels after being reflected by the reflective mirror, in order to receive the reflected light beam component having the predetermined wavelength and generate a fluorescence photon detection signal; and
an integration card unit for receiving the fluorescence photon detection signal, performing integration, and thereby generating the single-wavelength time-resolved signal.

6. The measurement system of claim 5, further comprising a synchronous signal converter for generating an electrical trigger signal to the integration card unit when subjected to photoexcitation of the excitation light source.

7. A measurement module applicable to a measurement system of a real-time spatially-resolved spectrum and time-resolved spectrum, comprising:
a light-collecting and splitting optical assembly for collecting fluorescence emitted by a fluorescent sample upon excitation, splitting the fluorescence according to wavelength, and thereby generating a multi-wavelength light beam of a plurality of wavelengths;
a single-photon linear scanner linearly movable along a path non-parallel to an optical path of the multi-wavelength light beam in order to selectively intercept a light beam component of the multi-wavelength light beam that has a predetermined wavelength and thereby generate a single-wavelength time-resolved signal;
a linear charge-coupled device (CCD) spectrometer located on the optical path of the multi-wavelength light beam in order to receive the multi-wavelength light beam and generate a spatially-resolved full-spectrum fluorescence signal; and
a control and processing module for receiving and analyzing the single-wavelength time-resolved signal and the spatially-resolved full-spectrum fluorescence signal.

8. The measurement module of claim 7, wherein the light-collecting and splitting optical assembly comprises:
a first off-axis parabolic mirror for collecting and reflecting the fluorescence;
a grating for receiving the fluorescence reflected by the first off-axis parabolic mirror, and for splitting the fluorescence according to wavelength and thereby generating the multi-wavelength light beam; and
a second off-axis parabolic mirror for receiving and reflecting the multi-wavelength light beam.

9. The measurement module of claim 8, wherein the grating has a reflective surface provided with a plurality of straight engraved lines arranged at a density of 300 to 2400 said straight engraved lines per millimeter.

10. The measurement module of claim 7, wherein the single-photon linear scanner comprises:
a stepper motor;
a stepper motor driver for driving the stepper motor into linear movement;
a reflective mirror connected to and linearly movable along with the stepper motor in order to selectively reflect the light beam component having the predetermined wavelength;
a single-photon avalanche diode (SPAD) detection element located on an optical path along which the light beam component having the predetermined wavelength travels after being reflected by the reflective mirror, in order to receive the reflected light beam component having the predetermined wavelength and generate a fluorescence photon detection signal; and
an integration card unit for receiving the fluorescence photon detection signal, performing integration, and thereby generating the single-wavelength time-resolved signal.
